(19) United States
(12) Patent Application Publication
(10) Pub. No.: US 2016/0141095 A1
(43) Pub. Date: May 19, 2016

(54) INDUCTOR FOR HIGH SIDE DC/DC CONVERTOR

(71) Applicant: Hyundai Motor Company, Seoul (KR)

(72) Inventors: Woo Young Lee, Cheongju (KR); Dae Woo Lee, Uljin-gun (KR); Si Hun Yang, Hwaseong (KR); Jin Young Yang, Hanam, Gyeonggi-do (KR); In Yong Yeo, Bucheon (KR); Byeong Seob Song, Yongin (KR)

(21) Appl. No.: 14/866,124

(22) Filed: Sep. 25, 2015

(30) Foreign Application Priority Data
Nov. 13, 2014 (KR) 10-2014-0157813

(51) Int. Cl. H01F 30/08; H01F 27/30; H01F 27/28

(52) U.S. Cl. CPC H01F 30/08; H01F 27/2823; H01F 27/306

(57) ABSTRACT

An inductor for a high side DC/DC convertor is provided for an environmentally friendly vehicle, which improves the property of DC bias. The inductor includes a core having a central core around which a wire is wound, a front core and a rear core that are attached integrally to a front and a rear of the central core, respectively, and a left core and a right core that are spaced from both sides of the central core and are attached integrally to the front core and the rear core. Additionally, a wire is wound around the central core in a length direction thereof.

### CROSS-REFERENCE TO RELATED APPLICATION

This application claims under 35 U.S.C. §119(a) the benefit of Korean Patent Application No. 10-2014-0157813 filed on Nov. 13, 2014, the entire contents of which are incorporated herein by reference.

### BACKGROUND

(a) Technical Field

The present disclosure relates to an inductor for a high side direct current-direct current (DC/DC) convertor, and more particularly, to an inductor for a high side DC/DC convertor for an environmentally friendly vehicle, which is improved structurally to improve the property of direct current (DC) bias.

(b) Background Art

In general, a DC/DC convertor is a device configured to generate alternative current by switching direct currents and increases or decreases voltage of the alternative current using a coil, transformer, and capacitor, and then rectifies the alternative current and converts it into direct current. A DC/DC convertor installed within a hybrid vehicle is configured to charge a supplementary battery by converting high voltage direct current into low voltage direct current and to monitor electric loads of a vehicle and supply electricity that corresponds to the voltage used at the respective electrical load.

In particular, a high side DC/DC convertor (HDC) is installed currently in a plug-in hybrid vehicle and an electric vehicle, which increases voltage of a high voltage battery and applies the voltage to a driving motor to drive the vehicle. The HDC is a device configured to increase an operation voltage of the driving motor and consists of various semiconductor elements.

The HDC uses a low switch frequency of severals of kHz to several tens of kHz and thus a size of an inductor core is substantial, and a maximum current capacity of the HDC is high of several hundreds of amperes and thus a wire of a substantial size for an inductor is required. Accordingly, many studies are being conducted regarding the reduction of the size of the HDC inductor wherein the representative study is made in a technology of using powder core.

When an inductor is manufactured using powder core as described, the inductor may be manufactured in a relative small size compared to a ferrite core, however, there is a disadvantage in that as the current to be applied to the inductor increases, the inductance decreases due to intrinsic property of the powder core, that is, DC bias property is deteriorated.

The above information disclosed in this section is merely for enhancement of understanding of the background of the invention and therefore it may contain information that does not form the prior art that is already known in this country to a person of ordinary skill in the art.

### SUMMARY

The present invention provides an inductor for a high side DC/DC convertor a size of which may be reduced compared to a conventional inductor and the property of DC bias of which may be improved by preventing inductance decrease when a high voltage is applied thereto.

In one aspect, the present invention provides an inductor for a high side DC/DC convertor that may include: a core having a central core around which a wire is wound, a front core and a rear core attached integrally to a front and a rear of the central core, respectively, and a left core and a right core that are spaced from both sides of the central core and are attached integrally to the front core and the rear core; and a wire wound around the central core in a lengthwise direction thereof.

In an exemplary embodiment, the core may further include: an upper core having a wire drawing groove through which both ends of the wire may be drawn out and may be attached to the upper surfaces of the front core and the rear core and the upper surfaces of the left core and the right core to cover the central core and the wire; and a lower core that may be attached to the lower surfaces of the front core and the rear core and the lower surfaces of the left core and the right core to cover the central core and the wire.

In another exemplary embodiment, the sectional areas of the front core and the rear core including the central core may be about 2 A as two times as 1 A of a standard size. In addition, the sectional areas of the left core and the right core may be about 0.7 A based on 1 A of a standard size. The sectional areas of the upper core and the lower core may be also be about 0.7 A based on 1 A of a standard size.

### BRIEF DESCRIPTION OF THE DRAWINGS

The above and other features of the present invention will now be described in detail with reference to exemplary embodiments thereof illustrated the accompanying drawings which are given herein below by way of illustration only, and thus are not limitative of the present invention, and wherein:

FIG. 1 is an exemplary top view illustrating an inductor for a high side DC/DC convertor according to an exemplary embodiment of the present invention;

FIG. 2 is an exemplary perspective view illustrating an inductor for a high side DC/DC convertor according to an exemplary embodiment of the present invention;

FIG. 3 is an exemplary perspective view illustrating an inductor for a high side DC/DC convertor except for an upper core according to an exemplary embodiment of the present invention;

FIG. 4 is an exemplary cross-sectional view illustrating an inductor for a high side DC/DC convertor according to an exemplary embodiment of the present invention;

FIG. 5 is an exemplary longitudinal-sectional view illustrating an inductor for a high side DC/DC convertor according to an exemplary embodiment the present invention; and

FIG. 6 is an exemplary perspective view illustrating an inductor according to a related art.

It should be understood that the appended drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the to rms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “a bout” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Firstly, as shown in FIG. 6, accordingly to the related art, a conventional inductor includes two cores 10 each having a “U” shape or two cores 10 manufactured as a “U” shape using multiple blocks. In particular, a wire 20 is wound around the core 10 in a direction of 1->2 and then 3->4, as shown in FIG. 6. In other words, the wire 20 is wound in a direction of 1->2, that is, along one surface of the core 10 and when it is impossible to be wound further thereon, the wire is moved to a direction of 3 and wound again in a direction of 3->4 along the core 10.

According to the conventional inductor configured as described above, a sectional area of a core is required to be of a particular substantial size or the winding number of a wire is required to be increased to ensure inductance of the inductor. However, when the sectional area of the core is of such a particular substantial size, a size of the core is increased as well as a length of the wire to be wound around the core.

Meanwhile, the property of DC bias is in proportion to a length of magnetic flux path and thus when the sectional area of the core is increased, the length of magnetic flux path is also increased and thus it will be advantageous to the property of DC bias, however, when the winding number of the wire is increased, the size of the inductor is required to be increased in directions of 1->2 and 3->4.

As a result, the property of DC bias is in inverse proportion to the winding number of the wire and thus when the winding number of the wire is increased, the property of DC bias may be deteriorated. Thus, an object of the present invention relates to providing an improved inductor considering that the property of DC bias may be improved when the sectional area of the core is increased and the winding number of the wire is decreased while maintaining the same inductance.

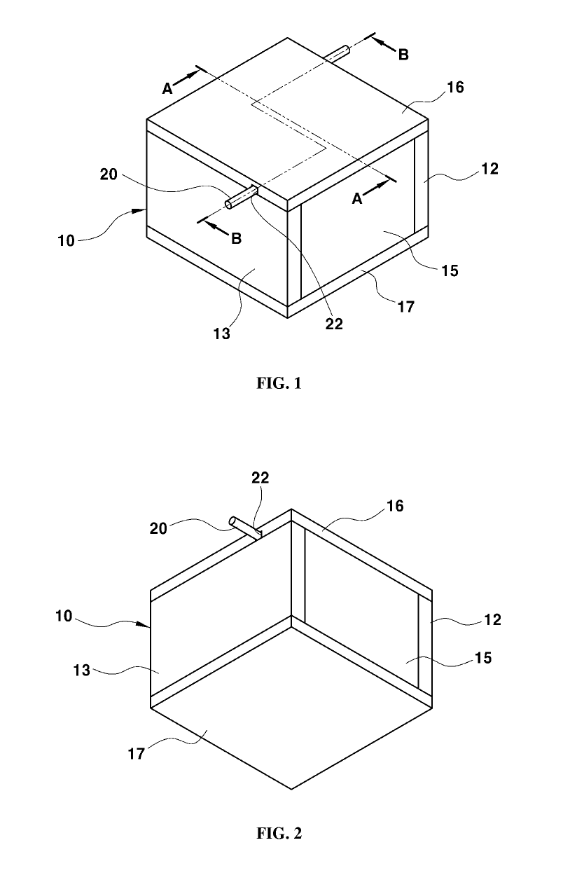

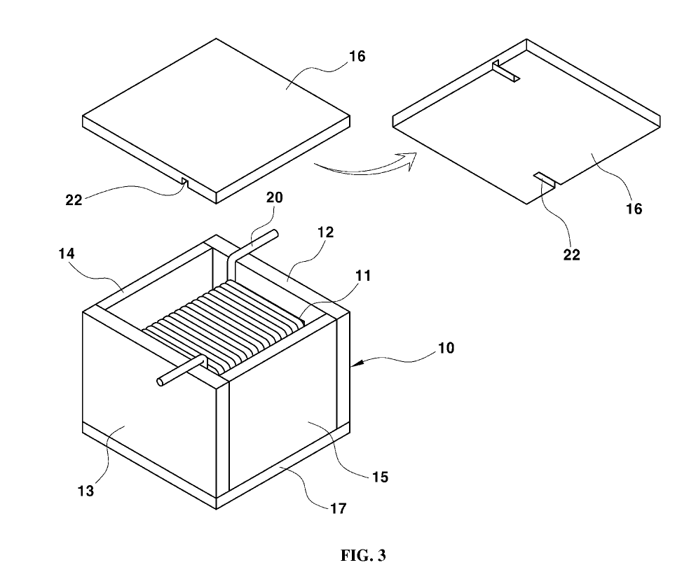

FIGS. 1 to 3 are exemplary views illustrating an inductor according to an exemplary embodiment the present invention. As shown in FIGS. 1 to 3, the core 10 forming the inductor of the present invention may include: a central core 11 around which a wire 20 may be wound; a front core 12 and a rear core 13 attached integrally to a front and a rear of the central core 11, respectively; a left core 14 spaced from both sides of the central core 11 and attached to one side of the front core 12 and the rear core 13; and a right core 15 spaced from both sides of the central core 11 and attached to the other side of the front core 12 and the rear core 13.

In particular, the wire 20 may be wound around the central core 11 along a length direction thereof and then the front core 12 and the rear core 13 may be attached to a front surface and a rear surface of the central core 11, respectively, using an attaching agent. Further, the left core 14 and the right core 15 may be attached to one side (e.g., a first side) and the other side (e.g., a second side) of the front core 12 and the rear core 13, respectively, using an attaching agent.

The core 10 forming the inductor of the present invention may further include: an upper core 16 having a wire drawing groove 22 through which both ends of the wire 20 may be drawn out and may be attached to the upper surfaces of the front core 12 and the rear core 13 and the upper surfaces of the left core 14 and the right core 15 using an attaching agent to cover the central core 11 and the wire 20; and a lower core 17 attached to the lower surfaces of the front core 12 and the rear core 13 and the lower surfaces of the left core 14 and the right core 15 using an attaching agent to cover the central core 11 and the wire 20.

Additionally, both ends of the wire 20 wound around the central core 11 may be exposed to the exterior through the wire drawing groove 22 formed through the upper core 16, respectively.

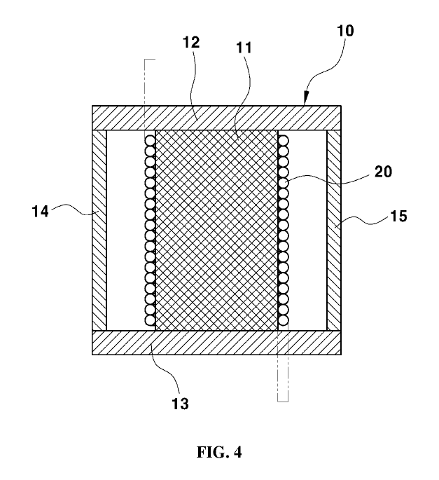

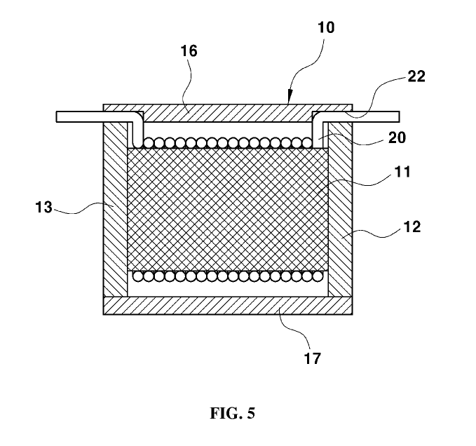

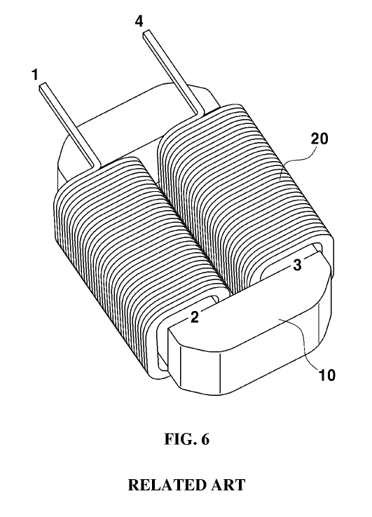

Referring to FIGS. 4 and 5, the sectional areas of the central core 11, the front core 12 and the rear core 13 forming the core 10 may be same and the sectional areas may be about 2 A as two times as 1 A (that is, the area) when the sectional area of a conventional “U” shaped-core is about 1A. Further, the sectional areas of the left core 14 and the right core 15 may be about the same to those of the upper core 16 and the lower core 17 and the sectional areas of the left core 14 and the right core 15 and the sectional areas of the upper core 16 and the lower core 17 may be about 0.7 A when the sectional area of a conventional “U” shape core is about 1 A.

As described herein above, when a sectional area of a conventional core formed by bonding two “U” shaped- cores is about 1 A, according to the present invention the sectional areas of the central core 11 and the front and rear cores 12, 13 may be about 2 A and the sectional areas of the left and right cores 14, 15 and the upper and lower cores 16, 17 may be about 0.7 A and thus the whole sectional area of the core may be doubled compared to the conventional core to decrease the winding number of the wire to ensure the same inductance of an inductor and to improve the property of DC bias with the decrease of the winding number of the wire.

Further, according to a related art as the wire is wound around both sides of the core, a total of 4 wires are disposed in a left and right direction, viewed from a cross-sectional direction. However, according to the present invention the wire 20 is wound around the central core 11 and thus two cores may be disposed in a left and right direction, viewed from a cross-sectional direction, thus producing a size advantage by a wire thickness*2. In other words, the claimed invention teaches an inductor that requires fewer wires to be wound, thus simplifying a structure of the related art.

As a result, according to the present invention, the sectional area of the core may be doubled compared to the related art thus decreasing number of windings of the core to ensure about the same inductance of an inductor, thus decreasing a longitudinal size of the central core compared to a conventional core of the related art.

According to the present invention, under a condition of maintaining about the same inductance using about the same inductor to that of a related art the sectional area of the core may be increased and simultaneously the winding number of the core may be decreased compared to the size of an inductor and thus an inductance decrease may be prevented when a substantially high current is applied, to thus improve the property of DC bias.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. An inductor for a high side direct current-direct current convertor, comprising:
a core including:
a central core around which a wire is wound;
a front core and a rear core attached integrally to a front and a rear of the central core, respectively; and
a left core and a right core spaced from both sides of the central core and attached integrally to the front core and the rear core; and
a wire wound around the central core in a length direction thereof.

2. The inductor for a high side DC/DC convertor of claim 1, wherein the core further includes:
an upper core having a wire drawing groove through which both ends of the wire are drawn out and attached to the upper surfaces of the front core and the rear core and the upper surfaces of the left core and the right core to cover the central core and the wire; and
a lower core attached to the lower surfaces of the front core and the rear core and the lower surfaces of the left core and the right core to cover the central core and the wire.

3. The inductor for a high side DC/DC convertor of claim 2, wherein the sectional areas of the front core and the rear core including the central core are about 2 A as two times as 1 A of a standard size.

4. The inductor for a high side DC/DC convertor of claim 2, wherein the sectional areas of the left core and the right core are about 0.7 A based on 1 A of a standard size.

5. The inductor for a high side DC/DC convertor of claim 2, wherein the sectional areas of the upper core and the lower core are about 0.7 A based on 1 A of a standard size.

6. The inductor for a high side DC/DC convertor of claim 1, wherein the left core and the right core are attached to a first side and a second side of the front core and the rear core, respectively using an attaching agent.
